(19) United States
(12) Patent Application Publication
(10) Pub. No.: US 2006/0220526 A1
(43) Pub. Date: Oct. 5, 2006

(54) Electron emission device, electron emission display device using the same, and method for manufacturing the same

(76) Inventor: Kyung-Sun Ryu, Yongin-si (KR)

Correspondence Address: LEE & MORSE, P.C., 1101 WILSON BOULEVARD, SUITE 2000, ARLINGTON, VA, 22209, US

(21) Appl. No.: 11/390,262

(22) Filed: Mar. 28, 2006

(30) Foreign Application Priority Data
Mar. 31, 2005 (KR) 10-2005-0026987

(51) Int. Cl. H01J 1/62

(52) U.S. Cl. 313/497

(57) ABSTRACT

An electron emission device including a substrate, a cathode electrode on the substrate, the cathode electrode having a main electrode and a subsidiary electrode, at least one resistance layer on the subsidiary electrode, the resistance layer varying in resistivity along a thickness direction of the resistance layer, and at least one electron emission region connected to the resistance layer.

### BACKGROUND OF THE INVENTION

1. Field of the Invention

The present invention relates to an electron emission device. More particularly, the present invention relates to an electron emission device that has driving electrodes for controlling the emission of electrons and a resistance layer for increasing the uniformity of electron emission for respective pixels, an electron emission display device using the electron emission device, and a method of manufacturing the same.

2. Description of the Related Art

In general, electron emission elements may be classified according to the kinds of electron sources used. Types of electron emission elements include a first type that uses a hot cathode and a second type that uses a cold cathode.

The second type of electron emission elements, i.e., the cold cathode type, includes field emitter array (FEA) type, surface conduction emission (SCE) type, metal-insulator-metal (MIM) type, and metal-insulator-semiconductor (MIS) type.

The FEA type operates on the principle that electrons may be easily emitted from an electron emission region when an electric field is applied to the electron emission region under a vacuum atmosphere. The electron emission region may be formed with a material having a low work function and/or a high aspect ratio, including, e.g., carbonaceous materials such as carbon nanotubes, graphite and diamond-like carbon.

An FEA type may have the electron emission region, as well as a cathode electrode and a gate electrode as driving electrodes for controlling the emission of electrons from the electron emission region. The electron emission elements may be formed on a substrate as an array of elements, in order to make an electron emission device. The electron emission device may be combined with another substrate having an anode electrode and a light emission unit based on a phosphor layer in order to make an electron emission display device.

A common example of a FEA-based electron emission display device includes first and second substrates that form a vacuum vessel. Electron emission regions are formed on the first substrate, together with cathode and gate electrodes as the driving electrodes. Phosphor layers are formed on a surface of the second substrate, facing the first substrate, together with an anode electrode for accelerating electrons emitted from the first substrate toward the phosphor layers.

The cathode electrodes are electrically connected to the electron emission regions to supply the electric currents that are required for emitting electrons. The gate electrodes control electron emission by creating electric fields based on a voltage difference between the gate electrodes and the cathode electrodes.

In practice, however, when the electron emission device is driven, the voltages applied to the electron emission regions arranged at respective pixels may differ. In particular, the voltages may differ between pixels due to internal resistance of the driving electrodes, e.g., the cathode electrodes. As a result, the amount of discharge current from the electron emission regions may be different between pixels. Thus, when the electron emission device is used as a light source or a display unit, a brightness difference may be perceived between pixels.

One possible solution to the uneven brightness is to reduce the resistance value of the material used for the driving electrodes. Another possible solution is to provide a resistance layer between the cathode electrode and the electron emission region. The resistance layer may be formed through screen-printing or thin film-doping a material having a specific resistivity. However, as the material having such a resistivity may be very expensive, the material cost may be increased. In addition, when the formation of a resistance layer is different from the usual formation process, separate equipment for forming the resistance layer may be required. Further, the resistance layers may be weak in terms of acid resistance, such that they may easily be damaged by an etching solution during an etching process.

### SUMMARY OF THE INVENTION

The present invention is therefore directed to an electron emission device, electron emission display device using the same, and method for manufacturing the same, which substantially overcome one or more of the problems due to the limitations and disadvantages of the related art.

It is therefore a feature of an embodiment of the present invention to provide an electron emission device configured to compensate for a voltage drop caused by internal resistance of electrodes, the electron emission device including a resistance layer that has a varying resistance in a thickness direction of the resistance layer.

It is therefore another feature of an embodiment of the present invention to provide an electron emission device including a resistance layer that exhibits etching resistance.

At least one of the above and other features and advantages of the present invention may be realized by providing an electron emission device including a substrate, a cathode electrode on the substrate, the cathode electrode having a main electrode and a subsidiary electrode, at least one resistance layer on the subsidiary electrode, the resistance layer varying in resistivity along a thickness direction of the resistance layer, and at least one electron emission region connected to the resistance layer.

The resistivity of the resistance layer may gradually vary in the thickness direction of the resistance layer. The resistivity of the resistance layer may increase from a surface of the resistance layer that contacts the subsidiary electrode to an opposite surface of the resistance layer that contacts the electron emission region. The subsidiary electrode may include a diffusive material. The diffusive material may be silver. The subsidiary electrode and the resistance layer may each include the diffusive material.

The main electrode may be transparent to ultraviolet light, and the subsidiary electrode may have at least one hole corresponding to an electron emission region. The thickness of the resistance layer may be in the range of about 1 μm to about 10 μm. The electron emission device may further include an insulating layer on the substrate, the insulating layer having openings that expose the electron emission regions, and gate electrodes on the insulating layer, the gate electrodes having openings corresponding to the openings of the insulating layer. The insulating layer and the resistance layer may include a same insulating material.

At least one of the above and other features and advantages of the present invention may also be realized by providing an electron emission display device including a first substrate and a second substrate facing each other, cathode electrodes on the first substrate, each cathode electrode having a main electrode and a subsidiary electrode, resistance layers on the subsidiary electrodes, the resistance layers varying in resistivity along a thickness direction of the resistance layers, electron emission regions connected to the resistance layers, gate electrodes separated from the cathode electrodes and having an insulating layer interposed therebetween, phosphor layers on a surface of the second substrate facing the first substrate, and at least one anode electrode adjacent to the phosphor layers.

The resistivity of the resistance layers may gradually vary in the thickness direction of the resistance layers. The resistivity of the resistance layers may increase from a surface of the resistance layer that contacts the subsidiary electrode to an opposite surface of the resistance layer that contacts the electron emission region. The subsidiary electrode may include silver. Separate resistance layers may be formed for each pixel.

At least one of the above and other features and advantages of the present invention may further be realized by providing a method of manufacturing an electron emission device including forming cathode electrodes on a substrate, forming diffusion target layers at predetermined locations on the cathode electrodes, and converting the diffusion target layers into resistance layers by diffusing a conductive diffusive material contained in the cathode electrodes into the diffusion target layers.

Forming the cathode electrodes on the substrate may include forming main electrodes on the substrate and forming subsidiary electrodes on the main electrodes, the subsidiary electrodes including the diffusive material. The diffusive material may be silver. The method may further include forming an insulating layer and gate electrodes on the substrate and forming electron emission regions such that the electron emission regions are connected to the resistance layers. Forming the diffusion target layers and forming the insulating layer may each be performed using a same insulating material. Forming the diffusion target layers and forming the insulating layer may each be performed under the same processing conditions.

Forming the electron emission regions may include coating a mixture containing an electron emission material and a photosensitive material onto the substrate, partially hardening the coated mixture using light exposure, and removing non-hardened portions of the coated mixture. The main electrodes may be formed with a transparent material and one or more holes may be formed in the subsidiary electrodes at each pixel, and partially hardening the coated mixture may include selectively illuminating ultraviolet light through the holes in the subsidiary electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial exploded perspective view of an electron emission display device according to an embodiment of the present invention;

FIG. 2 illustrates is a partial sectional view of the electron emission display device of FIG. 1;

FIG. 3 illustrates a sectional view of a resistance layer of FIG. 2;

FIG. 4 illustrates an exploded perspective view of an electron emission display device according to another embodiment of the present invention;

FIGS. 5A to 5G illustrate cross-sectional views of stages in a method of manufacturing an electron emission device according to an embodiment of the present invention; and

FIGS. 6A to 6D illustrate cross-sectional views of stages in a method of manufacturing an electron emission device according to another embodiment of the present invention.

### DETAILED DESCRIPTION OF THE INVENTION

Korean Patent Application No. 10-2005-0026987, filed on Mar. 31, 2005, in the Korean Intellectual Property Office and entitled: “Electron Emission Device, Electron Emission Display Device Using the Same, and Method for Manufacturing the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

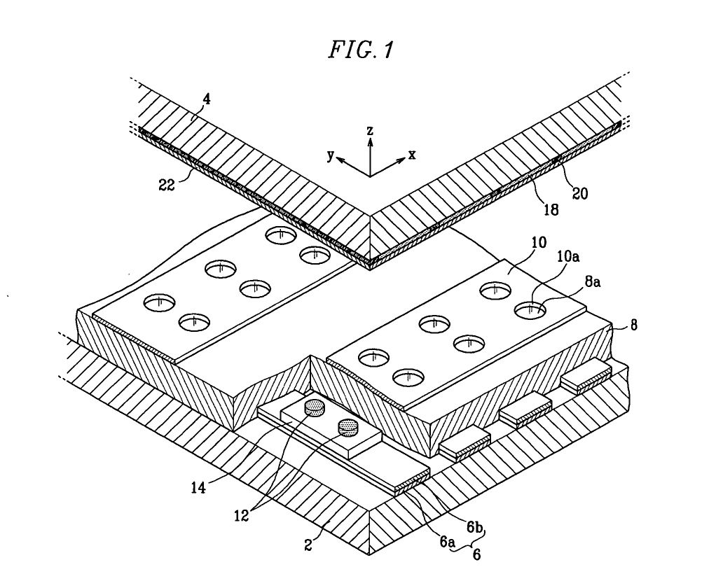

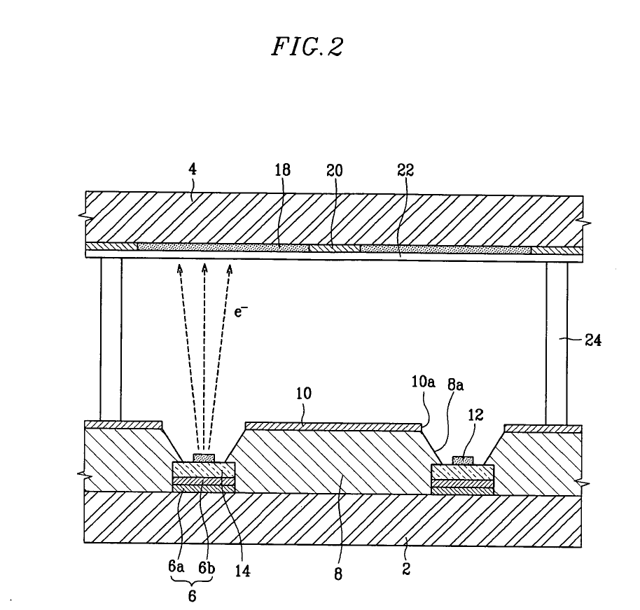

FIG. 1 illustrates a partial exploded perspective view of an electron emission display device according to an embodiment of the present invention, and FIG. 2 illustrates is a partial sectional view of the electron emission display device of FIG. 1. Referring to FIGS. 1 and 2, the electron emission display device according to an embodiment of the present invention may include first substrate 2 and second substrate 4 disposed to face each other, i.e., in parallel, and defining an inner space therebetween. Electron emission elements may be formed on the surface of the first substrate 2 that faces the second substrate 4. The electron emission elements may be regularly arranged, e.g., in an array, to make an electron emission device. A light emission unit may be provided at the second substrate 4. The light emission unit may employ a material, e.g., a phosphor, to emit visible light upon excitation by emitted electrons.

Cathode electrodes 6 may be disposed on the first substrate 2 in a striped pattern, and may extend along the first substrate 2 in, e.g., the direction of the y axis of FIG. 1. An insulating layer 8 may be formed on the entire surface of the first substrate 2, covering the cathode electrodes 6. Gate electrodes 10 may be disposed on the insulating layer 8 in a striped pattern, and may extend on the insulating layer 8 in a direction perpendicular to the cathode electrodes 6, e.g., in the direction of the x axis of FIG. 1. The regions where the cathode electrodes 6 and gate electrodes 10 cross are defined as pixels.

Resistance layers 14 may be formed on the cathode electrodes 6 at the respective pixels. Details of the formation of the resistance layers 14 are provided below. One or more electron emission regions 12 may be formed on each resistance layer 14. Openings 8a may be formed in the insulating layer 8 and openings 10a may be formed in the gate electrodes 10. The openings 8a, 10a may be positioned to correspond to the respective electron emission regions 12, in order to expose the electron emission regions 12.

Each cathode electrode 6 may have a two-layer structure, wherein a main electrode 6a is overlaid with a subsidiary electrode 6b. The subsidiary electrode 6b may have a smaller resistance value than the main electrode 6a, in order to reduce the line resistance of the cathode electrode 6.

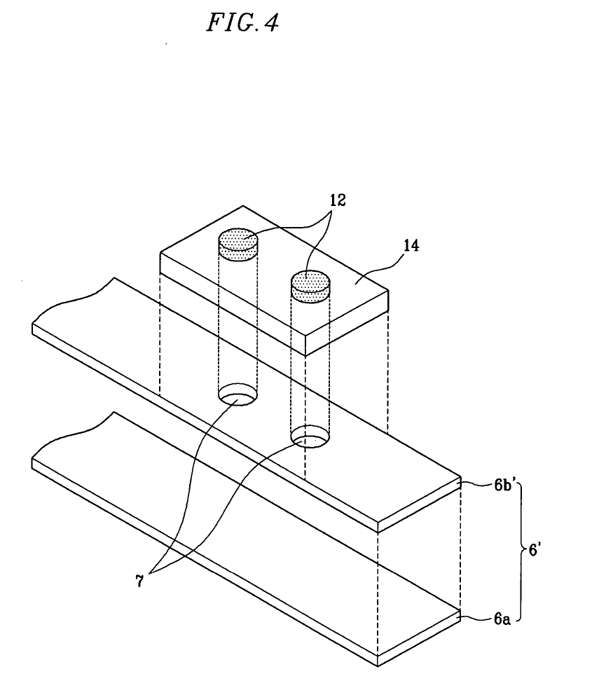

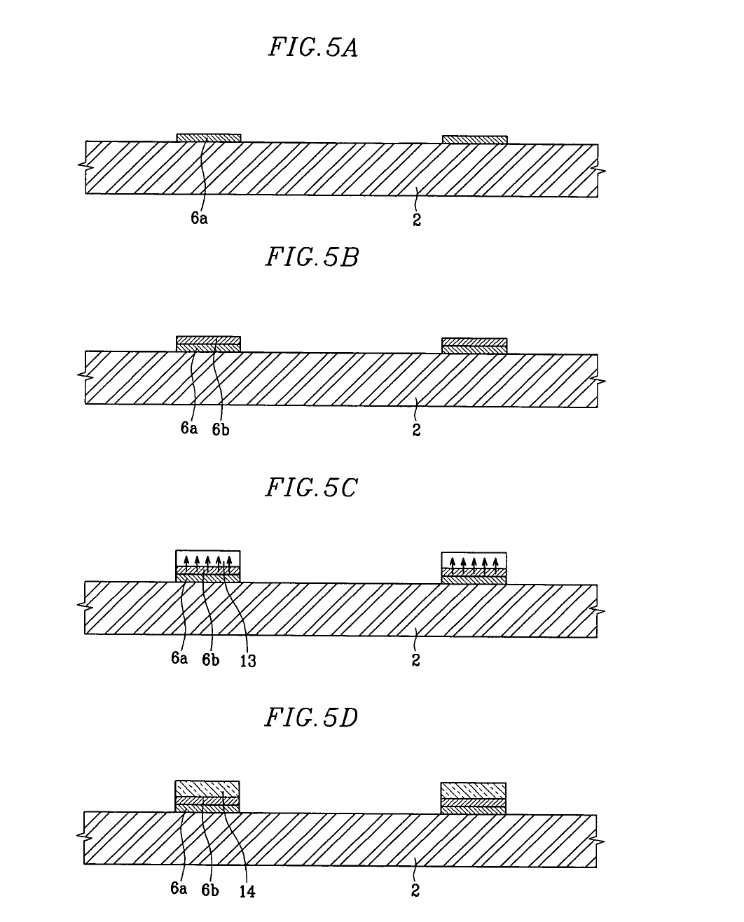

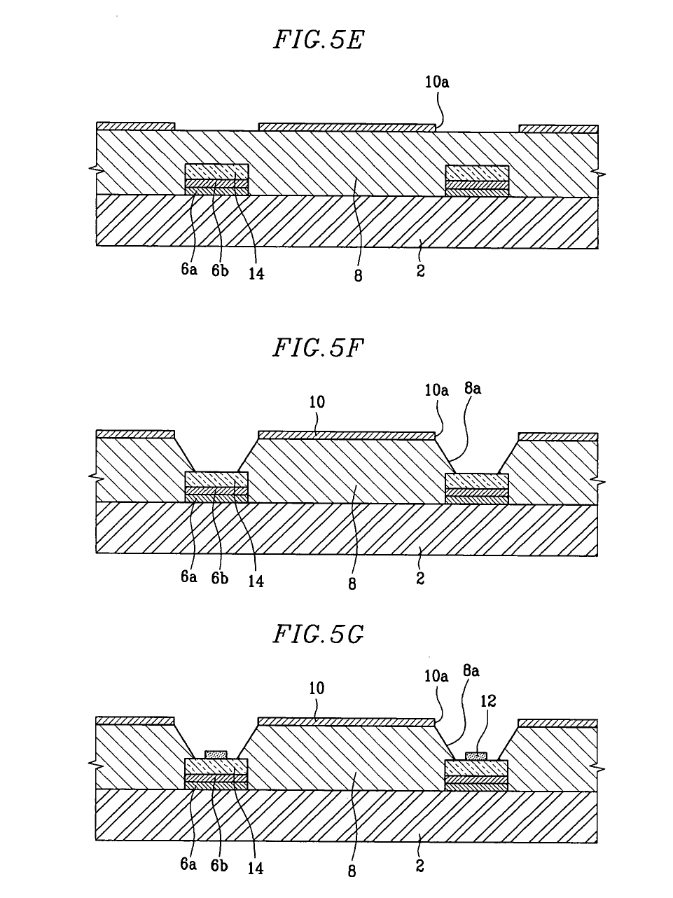

The main electrode 6a may be formed with a transparent material, e.g., indium tin oxide (ITO). The subsidiary electrode 6b may be formed with a diffusive material, e.g., silver (Ag) having a high diffusion coefficient. During processing of the electron emission display device, the subsidiary electrode 6b may diffuse the inner conductive material thereof to a diffusion target layer 13 (shown in FIG. 5C) to convert the diffusion target layer 13 into the resistance layer 14 that exhibits a predetermined range of resistivity. This process will be described in additional detail below.

In the case that a voltage drop is caused by the resistance of the cathode electrode 6, the resistance layer 14 may enable more uniform control over the voltage conditions of the pixels. In particular, the resistance layer 14 has a greater resistance value than the cathode electrode 6, thereby increasing the entire line resistance of the cathode electrode 6 and decreasing the entire amount of discharge current per pixel. In addition, the resistance layer 14 may decrease the difference in the amount of discharge current between the pixels. Thus, the resistance layer 14 may lower and balance the amount of discharge current per pixel.

The resistance layer 14 exhibits differing resistivity along the thickness direction thereof, i.e., in the direction of the z axis of FIG. 1. In particular, the resistivity of the resistance layer 14 may be gradually varied. For instance, the resistivity of the resistance layer 14 may increase along the thickness direction, as determined from the surface that contacts the subsidiary electrode 6b toward the opposite surface that contacts the electron emission region 12. The resistivity of the resistance layer 14 depends upon a varying density and concentration of a diffusive material therein, i.e., the density and concentration varies in the thickness direction. The diffusive material may be, e.g., silver, as described above.

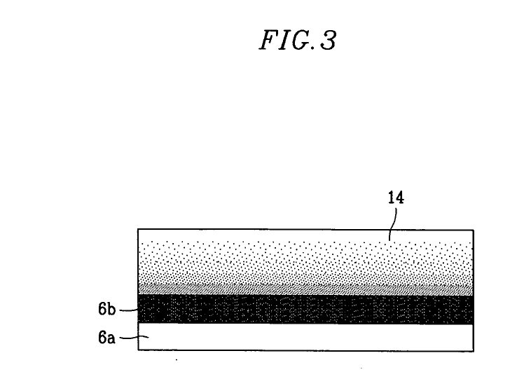

FIG. 3 illustrates a sectional view of a resistance layer shown in FIG. 2. Referring to FIG. 3, the density and concentration of the diffusive material within the resistance layer 14 is gradually reduced from the surface thereof that contacts the subsidiary electrode 6b toward the opposite surface that contacts the electron emission region 12. When the diffusive material has low resistivity, the portions thereof where the distribution of the specific material is greater have proportionally lower resistance values. The resistivity may vary within the range of about 10³ Ω·cm to about 10⁹ Ω·cm. The variation in resistivity will be described in additional detail below. The resistance layer 14 may have a thickness of about 1 to about 10 μm.

The electron emission regions 12 may be formed with a material that emits electrons when an electric field is applied thereto under a vacuum atmosphere, e.g., a carbonaceous material, a nanometer (nm) size material, etc. The electron emission regions 12 may be formed with carbon nanotubes, graphite, graphite nanofiber, diamond, diamond-like carbon, fullerene C₆₀, silicon nanowire, etc., and combinations thereof.

The electron emission regions 12 may be circular or cylindrical, and may be arranged at the respective pixels in, e.g., a row in the longitudinal direction of the cathode electrodes 6, as illustrated in FIGS. 1 and 2.

However, other shapes, arrangements and numbers of electron emission regions 12 per pixel may be selected, and the present invention is not limited to the illustrated electron emission display device.

Likewise, the resistance layer 14 may be rectangular and may cover the entire area of each pixel, but the shape and location thereof may be altered in various manners, and the present invention is not limited to the illustrated electron emission display device. For example, the resistance layer 14 may be separately provided under the respective electron emission regions 12 within each pixel.

FIG. 4 illustrates an exploded perspective view of an electron emission display device according to another embodiment of the present invention. Referring to FIG. 4, a cathode electrode 6′ may have a subsidiary electrode 6b′ that has one or more holes 7 in the portion of the subsidiary electrode 6b′ within each pixel. The holes 7 may be positioned corresponding to the respective electron emission regions 12, any may be utilized during the formation of the electron emission regions 12 to allow ultraviolet light to pass through the subsidiary electrode 6b′, as described in detail below. The size of the hole 7 may be slightly larger than the size of the electron emission region 12. The shape, size and arrangement of the holes 7 may be altered in various manners. The holes 7 may be formed depending upon the processing characteristics of the electron emission regions 12, which will be described below.

A focusing electrode (not shown) may be formed on the gate electrodes 10 and the insulating layer 8 to focus the electrons emitted from the electron emission regions 12. Denoting the insulating layer 8 as the first insulating layer, a second insulating layer (not shown) may be formed between the gate electrodes 10 and the focusing electrode to insulate them from each other.

Phosphor layers 18 and black layers 20 may be formed on a surface of the second substrate 4 facing the first substrate 2, and an anode electrode 22 may be formed on the surfaces of the phosphor layers 18 and black layers 20. The anode electrode 22 may be formed with a metallic material, e.g., aluminum. In operation, the anode electrode 22 receives a high voltage that is used to accelerate the electron beams. The anode electrode 22 may also reflect visible light emitted from the phosphor layers 18 to the outside of the electron emission display. In particular, the anode electrode 22 may take visible light that is emitted by the phosphor layers 18 in the direction of the first substrate and reflect it back, toward the outside of the second substrate 4, thereby enhancing screen brightness.

In another implementation (not shown), the anode electrode 22 may be formed with a transparent material such as ITO. In this case, the anode electrode may be disposed on the outer surfaces of the phosphor layers 18 and the black layers 20, i.e., arranged such that the phosphor layers 18 and the black layers 20 are between the anode electrode 22 and the first substrate 2. The anode electrode 22 may be patterned as a plurality of separate electrode portions.

Spacers 24 may be provided between the first substrate 2 and the substrate 4 to maintain a constant distance therebetween. The spacers 24 may be positioned so as to correspond to the non-light-emitting areas of the black layer 20.

The electron emission display device described above may be operated by applying predetermined voltages to the cathode electrodes 6, the gate electrodes 10 and the anode electrode 22. For instance, driving voltages with a voltage difference of several volts to several tens of volts may be applied to the cathode electrodes 6 and the gate electrodes 10, and a positive (+) voltage of several hundreds of volts to several thousands of volts may be applied to the anode electrode 22. Accordingly, electrons may be emitted from the electron emission regions 12 at the pixels where the voltage difference between the cathode electrodes 6 and the gate electrodes 10 exceeds a threshold value. The emitted electrons may then be attracted by the high voltage applied to the anode electrode 22, and then collide against the respective phosphor layers 18 to cause visible light emission.

In operation, the resistance layers 14 formed at the cathode electrodes 6 help compensate for any positional voltage differences of the cathode electrode 6, which may enhance the uniformity of the amount of discharge current per pixel.

A method of manufacturing an electron emission device according to an embodiment of the present invention will now be explained with reference to FIGS. 5A to 5G, which illustrate cross-sectional views of stages in a method of manufacturing an electron emission device according to an embodiment of the present invention.

Referring to FIG. 5A, a transparent conductive material such as ITO may be coated on a first substrate 2 in, e.g., a stripe pattern, to form main electrodes 6a. Subsequently, referring to FIG. 5B, a subsidiary electrode 6b may be formed on each main electrode 6a in conformity with the pattern of the main electrode 6a. As explained above, the material for the subsidiary electrode 6b may be silver with a high diffusion coefficient.

FIGS. 5C and 5D illustrate the transformation of a diffusion target layer 13 into the resistance layer 14. Referring to FIGS. 5C and 5D, an insulating paste may be coated onto the subsidiary electrode 6b to form the diffusion target layer 13 at each pixel. The diffusion target layer 13 may be formed with a paste for the insulating layer 8 (to be formed later) using the same processing equipment and steps as for the insulating layer 8. The diffusion target layer 13, formed on the subsidiary electrode 6b, may be heated or fired such that some of the conductive diffusive material in the subsidiary electrode 6b is diffused into the diffusion target layer 13. The diffusion direction of the diffusive material is indicated by the upward-pointing arrows in FIG. 5C.

The diffusion causes changes in the properties of the diffusion target layer 13. As illustrated, the diffusion target layer 13 is converted into the resistance layer 14, with the initial insulating properties of the diffusion target layer 13 decreasing while conductive properties of the resistance layer 14, which is being formed, are developed.

In particular, the resistivity of the resistance layer 14 increases as the distance from the subsidiary electrode 6b increases, as determined in the thickness direction of the resistance layer 14. The increasing resistivity is because the amount of diffusion of the conductive material from the subsidiary electrode 6b is reduced as the distance from the subsidiary electrode 6b increases. Consequently, as described above, the resistivity of the resistance layer 14 gradually varies in the thickness direction thereof.

In order to increase the rate of diffusion of the conductive diffusive material of the subsidiary electrode 6b into the diffusion target layer 13 during the firing process, the subsidiary electrode 6b may be formed with a material having a high diffusion coefficient.

The final resistivity of the resistance layer 14 is dependant upon the heating/firing temperature, the firing time and the components of the diffusive material. Accordingly, for example, in order to lower the resistivity of the resistance layer 14, the firing temperature and firing time may be increased, thereby causing the amount of diffusion to increase and decreasing the resistivity of the resistance layer 14. Thus, it is apparent that the resistivity of the resistance layer 14 may be controlled in a straightforward manner, e.g., by varying the processing temperature, time, etc. Moreover, processing is simplified because the subsidiary electrode of the existent structure is directly used.

In contrast, conventionally, resistivity may be controlled by varying the concentration of a dopant in amorphous silicon (a-Si). However, uniformly controlling the resistivity of a doped amorphous silicon layer may be more difficult in the conventional method than in the method according to the present invention, as described above.

Referring to FIG. 5E, an insulating material may be coated onto the entire surface of the first substrate 2 to form the insulating layer 8. A conductive layer may then be formed on the insulating layer 8, and openings 10a may be formed in the conductive layer using, e.g., a mask layer (not shown).

Referring to FIG. 5F, structures formed on the first substrate 2 may be etched, e.g., by dipping in an etching solution. Portions of the insulating layer 8 that are exposed through the openings 10a of the conductive layer may thus be etched to form the openings 8a in the insulating layer 8. The conductive layer may then be patterned, e.g., in a striped pattern, to complete the gate electrodes 10.

Referring to FIG. 5G, electron emission regions 12 may be formed on the resistance layers 14. The electron emission regions 12 may be formed using various suitable techniques, e.g., direct growth, chemical vapor deposition, sputtering, screen printing, etc.

Final operations (not shown) may include mounting spacers on the electron emission device, forming phosphor and black layers and an anode electrode on the second substrate, attaching the first and second substrates to each other at the peripheries thereof using, e.g., a glass frit, and evacuating the internal space between the substrates.

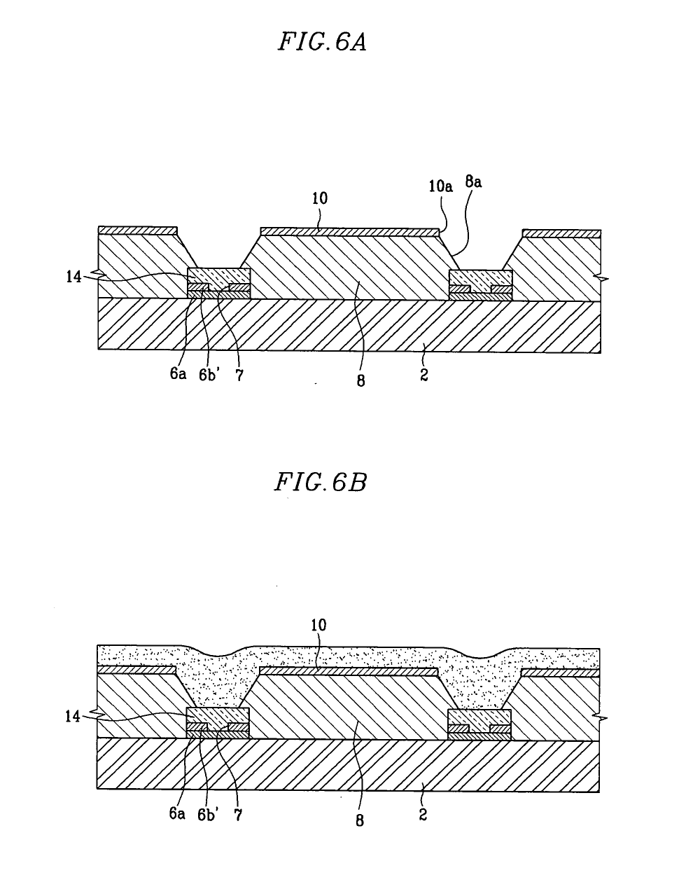

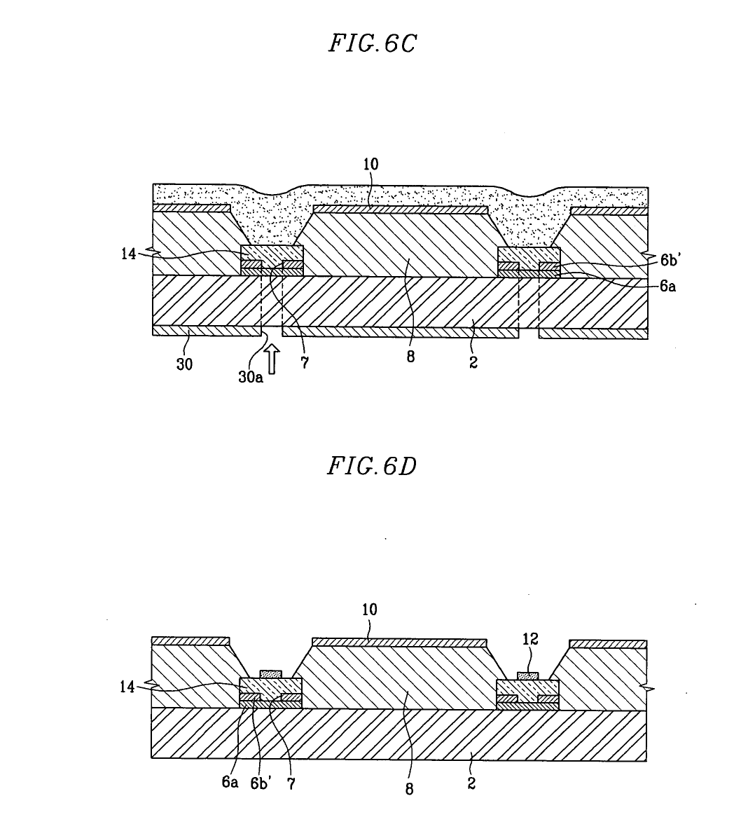

A method of manufacturing an electron emission device according to another embodiment of the present invention will now be explained with reference to FIGS. 6A to 6D, which illustrate cross-sectional views of stages in a method of manufacturing an electron emission device. Main electrodes 6a, subsidiary electrodes 6b′, resistance layers 14, an insulating layer 8 and gate electrodes 10 may be formed as described above. In addition, one or more holes 7 may be formed in the subsidiary electrode 6b′ at each pixel to allow for ultraviolet curing. The hole 7 may be formed using, e.g., a patterned mask layer (not shown). Note that, even with the presence of the hole 7, the subsidiary electrode 6b′ diffuses the diffusive material into the diffusion target layer 13 during firing, thereby converting it into the resistance layer 14.

FIG. 6A illustrates the formation of the main electrodes 6a, the subsidiary electrodes 6b′ with the holes 7, the resistance layers 14, the insulating layer 8, and the gate electrodes 10. Details of the operations for forming these elements are set forth above.

Referring to FIG. 6B, a paste-phase mixture containing an electron emission material and a photosensitive material, e.g., an ultraviolet light-hardenable material, may be prepared and coated onto the entire surface of the structure on the first substrate 2.

Referring to FIG. 6C, a light exposure mask 30 may be mounted at the rear of the first substrate 2, the light exposure mask 30 having openings 30a formed at positions corresponding to the locations of the holes 7 of the subsidiary electrodes 6b′. Ultraviolet light (indicated by the arrow) may be illuminated from the backside of the first substrate 2, and through the holes 7 and the openings 30a, in order to harden portions of the paste-phase mixture overlying the resistance layer 14 and corresponding to the holes 7.

That is, because the subsidiary electrodes 6b′ do not transmit ultraviolet light, the paste-phase mixture is not hardened unless holes are provided at the subsidiary electrodes 6b′. Further, the resistance layer 14 may be transparent, so that even after the conductive material is diffused therein, the backside light exposure can be employed.

In another implementation (not shown) the light exposure mask 30 may be omitted. In particular, even when the light exposure mask 30 is not provided, the backside light exposure may be employed by using the holes 7 to control exposure.

Referring to FIG. 6D, any unhardened mixture is removed through developing, and the remaining, hardened mixture, i.e., the mixture corresponding to the ultraviolet light-illuminated portions, is dried and fired, thereby forming electron emission regions 12.

According to the present invention, since the conductive material of the subsidiary electrode is diffused to the diffusion target layer to convert it into the resistance layer, the resistance layer can be easily formed without extra processing steps. Furthermore, the material for the resistance layer may be cost-effective, and may be highly acid-resistant so that it is not damaged by the etching solution during the etching process.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission device, comprising:
a substrate;
a cathode electrode on the substrate, the cathode electrode having a main electrode and a subsidiary electrode;
at least one resistance layer on the subsidiary electrode, the resistance layer varying in resistivity along a thickness direction of the resistance layer; and
at least one electron emission region connected to the resistance layer.

2. The electron emission device as claimed in claim 1, wherein the resistivity of the resistance layer gradually varies in the thickness direction of the resistance layer.

3. The electron emission device as claimed in claim 1, wherein the resistivity of the resistance layer increases from a surface of the resistance layer that contacts the subsidiary electrode to an opposite surface of the resistance layer that contacts the electron emission region.

4. The electron emission device as claimed in claim 1, wherein the subsidiary electrode includes a diffusive material.

5. The electron emission device as claimed in claim 4, wherein the diffusive material is silver.

6. The electron emission device as claimed in claim 4, wherein the subsidiary electrode and the resistance layer each include the diffusive material.

7. The electron emission device as claimed in claim 1, wherein the main electrode is transparent to ultraviolet light, and the subsidiary electrode has at least one hole corresponding to an electron emission region.

8. The electron emission device as claimed in claim 1, wherein the thickness of the resistance layer is in the range of about 1 μm to about 10 μm.

9. The electron emission device as claimed in claim 1, further comprising:
an insulating layer on the substrate, the insulating layer having openings that expose the electron emission regions; and
gate electrodes on the insulating layer, the gate electrodes having openings corresponding to the openings of the insulating layer.

10. The electron emission device as claimed in claim 9, wherein the insulating layer and the resistance layer include a same insulating material.

11. An electron emission display device, comprising:
a first substrate and a second substrate facing each other;
cathode electrodes on the first substrate, each cathode electrode having a main electrode and a subsidiary electrode;
resistance layers on the subsidiary electrodes, the resistance layers varying in resistivity along a thickness direction of the resistance layers;
electron emission regions connected to the resistance layers;
gate electrodes separated from the cathode electrodes and having an insulating layer interposed therebetween;
phosphor layers on a surface of the second substrate facing the first substrate; and
at least one anode electrode adjacent to the phosphor layers.

12. The electron emission display device as claimed in claim 11, wherein the resistivity of the resistance layers gradually varies in the thickness direction of the resistance layers.

13. The electron emission display device as claimed in claim 11, wherein the resistivity of the resistance layers increases from a surface of the resistance layer that contacts the subsidiary electrode to an opposite surface of the resistance layer that contacts the electron emission region.

14. The electron emission display device as claimed in claim 11, wherein the subsidiary electrode includes silver.

15. The electron emission display device as claimed in claim 11, wherein separate resistance layers are formed for each pixel.

16. A method of manufacturing an electron emission device, comprising:
forming cathode electrodes on a substrate;
forming diffusion target layers at predetermined locations on the cathode electrodes; and
converting the diffusion target layers into resistance layers by diffusing a conductive diffusive material contained in the cathode electrodes into the diffusion target layers.

17. The method as claimed in claim 16, wherein forming the cathode electrodes on the substrate includes:
forming main electrodes on the substrate; and
forming subsidiary electrodes on the main electrodes, the subsidiary electrodes including the diffusive material.

18. The method as claimed in claim 16, wherein the diffusive material is silver.

19. The method as claimed in claim 16, further comprising:
forming an insulating layer and gate electrodes on the substrate; and
forming electron emission regions such that the electron emission regions are connected to the resistance layers.

20. The method as claimed in claim 19, wherein forming the diffusion target layers and forming the insulating layer are each performed using a same insulating material.

21. The method as claimed in claim 20, wherein forming the diffusion target layers and forming the insulating layer are each performed under the same processing conditions.

22. The method as claimed in claim 19, wherein forming the electron emission regions includes coating a mixture containing an electron emission material and a photosensitive material onto the substrate, partially hardening the coated mixture using light exposure, and removing non-hardened portions of the coated mixture.

23. The method as claimed in claim 22, wherein the main electrodes are formed with a transparent material and one or more holes are formed in the subsidiary electrodes at each pixel, and
partially hardening the coated mixture includes selectively illuminating ultraviolet light through the holes in the subsidiary electrodes.

24. The method as claimed in claim 16, wherein diffusing a conductive diffusive material is conducted by firing.
